(19) United States
(12) Patent Application Publication
(10) Pub. No.: US 2020/0107909 A1
(43) Pub. Date: Apr. 9, 2020

(54) BRACE

(71) Applicant: YUN-WEN DENG, New Taipei City (TW)

(72) Inventor: YUN-WEN DENG, New Taipei City (TW)

(21) Appl. No.: 16/153,815

(22) Filed: Oct. 7, 2018

(51) Int. Cl. A61C 7/08

(52) U.S. Cl. CPC A61C 7/08; A61C 7/36

(57) ABSTRACT

The present invention discloses a brace for using with a corrective dental arch and an occlusal dental arch. The brace comprises a plurality of elastic arms, extensive portions and corrective portions. Each of the elastic arms is in contact with an inner side or an outer side of the corrective dental arch, and does not exceed a lowest occlusal surface of the corrective dental arch. The corrective portions are connected with the elastic arms via the extensive portions, and are in contact with a highest occlusal surface of the corrective dental arch so that the corrective portions exceed the highest occlusal surface. In addition, the corrective portions have a corrective plane that can occlude with the occlusal dental arch to generate an occlusal force substantially perpendicular to the highest occlusal surface.

### FIELD OF THE INVENTION

The present invention relates to a dental brace for correcting teeth, particularly to a brace for a malocclusion between teeth occlusion.

### BACKGROUND OF THE INVENTION

In addition to affecting chewing or pronunciation function, a malocclusion can result in oral problems such as tooth decay, periodontal disease or abnormal tooth wear so people nowadays tend to correct their teeth for aesthetics and health reasons.

One general steps to correct teeth are attaching a brace on a surface of each tooth, mounting a correct wire on each of the braces, and then pulling the correct wire together to change the arrangement of the teeth thereby changing overall appearance of the teeth and malocclusion. However, both the existing braces and correct wire are attached to the outer side of the teeth, so both of them are located on the buccal side of a patient. Therefore, this can not only aesthetically affect the appearance of the teeth of the patient, but also cause bleeding inside the cheek because the braces and the correct wire scratch the cheek.

Some patients may use a transparent brace to correct teeth for an aesthetics reason in order to prevent from disadvantages resulted from using the braces and correct wire. The transparent brace can apply a horizontal force to a side surface of a dental arch when mounted in the dental arch in order to adjust the teeth to a predetermined position. However, it is difficult for the current transparent brace to apply a perpendicular force to correct teeth if there are no additional components, for example, a spring and correct wire, mounted on the transparent brace. Therefore, it is difficult for the transparent brace to correct malocclusion.

### SUMMARY OF THE INVENTION

The primary purpose of the present invention is for correcting malocclusion between an upper and a lower dental arch. A brace of the present invention can form a correcting force perpendicular to an occlusal surface when occlusion between the upper and the lower dental arch occurs, such that protruding teeth in the dental arch can be corrected by the correcting force.

The secondary purpose of the present invention is for solving the problem of malaligned tooth and malocclusion of the teeth simultaneously. In addition to generating the correcting force substantially perpendicular to the occlusal surface, the brace of the present invention can also generate a flexible force to allow that a corrective dental arch can be corrected both from the correcting force and the flexible force, thereby reducing the correction time and increasing efficiency.

For achieving the purposes, the present invention is associated with a brace that can be mounted in a corrective dental arch, and be used with an occlusal dental arch located on a side of the corrective dental arch. The corrective dental arch has a plurality of occlusal surfaces with different heights and the brace comprises a plurality of elastic arms, at least one extensive portion and at least one corrective portion.

The plurality of elastic arms is in contact with an inner side or an outer side of the corrective dental arch and do not exceed a lowest occlusal surface. One end of the extensive portions is formed on the elastic arms, and the height of the other end is as high as a highest occlusal surface. Furthermore, the corrective portion is in contact with the highest occlusal surface and is formed on the extensive portion. Also, the corrective portion forms a corrective plane at a side that is away from the occlusal surfaces in which the corrective plane occludes with the occlusal dental arch for occlusion. Therefore, a portion of the corrective dental arch is subject to a correcting force that is substantially perpendicular to the highest occlusal surface for teeth correction.

The brace has a corrective contour that is larger or smaller than the contour of the corrective dental arch, and the elastic arms are deformed due to a press or expansion from the corrective dental arch when the brace is mounted in the corrective dental arch, such that a flexible force parallel to the occlusal surfaces is generated by the elastic arms to correct the corrective dental arch.

In a preferred embodiment, the elastic arms connects with each other to form a U-shaped elastic arm, an inner side or an outer side of the U-shaped elastic are forms the corrective contour. The U-shaped elastic arm deforms utilizing a connection between two of the elastic arms as supporting points so as to form a flexible force, and two opposing ends of the U-shaped elastic arm have the extensive portion and corrective portion, respectively.

In another preferred embodiment, the elastic arms connect with each other to further form an auxiliary U-shaped elastic arm connected to the U-shaped elastic arm that encloses the corrective dental arch jointly with the auxiliary U-shaped elastic arm, such that one of the U-shaped elastic arm and the auxiliary U-shaped elastic arm is located at an inner side of the corrective dental arch and the other of the U-shaped elastic arm and the auxiliary U-shaped elastic arm is located at an outer side of the corrective dental arch.

The U-shaped elastic arm and the auxiliary U-shaped elastic arm jointly form an opening which allows the corrective dental arch to penetrate through, and the extensive portions are above both of the U-shaped elastic arm and the auxiliary U-shaped elastic arm. Accordingly, the opening has a covering potion covered by the corrective portions and an exposure portion not covered by the corrective portions.

In yet another embodiment, two opposing ends of the corrective portion form the extensive portions and the elastic arms in sequence, respectively, and the elastic arms, the extensive portions and the corrective portion jointly form the corrective contour. The elastic arms utilize the extensive portions as supporting points to deform so as to generate the flexible force, wherein the extensive portions have a plurality of elastic arms connected with each other at an end that is away from the corrective portion so that the elastic arms jointly enclose a portion of the corrective dental arch.

In three above-mentioned embodiments, one of the elastic arms, extensive portions and corrective portions has a connecting portion that connects to a resilient member so that an external force is applied to the elastic arms by the resilient member in a direction that is different from the correcting force.

The feature of the present invention is that elastic arms do not exceed a lowest occlusal surface of a corrective dental arch, and corrective portions are in contact with a highest occlusal surface of the corrective dental arch. A portion of teeth of the corrective dental arch and an occlusal dental arch occludes with the corrective portions when occlusion between the corrective and the occlusal dental arch occurs while the rest teeth of the corrective and the occlusal dental arch do not occlude during occlusion. Accordingly, a substantially perpendicular correcting force is generated and applied to the portion of teeth of the corrective dental arch by the corrective portions, thereby correcting the portion of teeth so as to improve malocclusion between the corrective and the occlusal dental arch.

Furthermore, the elastic arms are deformed due to a press or expansion from the corrective dental arch when the brace of the present invention is mounted in the corrective dental arch, so a flexible force that is substantially parallel to the occlusal surface is generated from the elastic arms; therefore, the corrective dental arch can be corrected from the correcting force and the flexible force when occlusion between the corrective dental arch and the occlusal dental arch occurs, thereby reducing the correction time and increasing efficiency.

### BRIEF DESCRIPTION OF THE DRAWINGS

FIG. 1A is an illustrative view of a brace of the present invention detached from a corrective dental arch according to a first preferred embodiment;

FIG. 1B is a side view of a brace of the present invention mounted in a corrective dental arch according to the first preferred embodiment;

FIG. 1C is a top view of a brace of the present invention mounted in a corrective dental arch according to the first preferred embodiment;

FIG. 1D is an illustrative view when occlusion between a corrective dental arch and an occlusal dental arch occurs according to the first preferred embodiment;

FIG. 2A is an illustrative view of a brace of the present invention detached from a corrective dental arch according to a second preferred embodiment;

FIG. 2B is a top view of a brace of the present invention mounted in a corrective dental arch according to the second preferred embodiment;

FIG. 2C is an illustrative view of elastic arms located at a lingual side of a corrective dental arch that generates a flexible force;

FIG. 2D is an illustrative view when occlusion between a corrective dental arch and an occlusal dental arch occurs according to the second preferred embodiment;

FIG. 3A is a top view of a brace of the present invention mounted in a corrective dental arch according to a third preferred embodiment;

FIG. 3B is a side view of a brace of the present invention mounted in a corrective dental arch according to the third preferred embodiment;

FIG. 3C is an illustrative view when occlusion between a corrective dental arch and an occlusal dental arch occurs according to the third preferred embodiment;

FIG. 3D is an illustrative view of elastic arms generating a flexible force according to the third preferred embodiment;

FIG. 4A is a top view of a brace of the present invention mounted in a corrective dental arch according to a fourth preferred embodiment;

FIG. 4B is a side view of a brace of the present invention mounted in a corrective dental arch according to the fourth preferred embodiment;

FIG. 5A is a top view of a brace of the present invention mounted in a corrective dental arch according to a fifth preferred embodiment;

FIG. 5B is a side view of a brace of the present invention mounted in a corrective dental arch according to the fifth preferred embodiment; and

FIG. 6 is a side view of a brace of the present invention mounted in a corrective dental arch according to a sixth preferred embodiment.

### DETAILED DESCRIPTION OF THE PREFERRED EMBODIMENTS

For the purpose of further realizing and understanding the structures, use and features of the present invention, preferred embodiments are provided and described in detail with the accompanying figures.

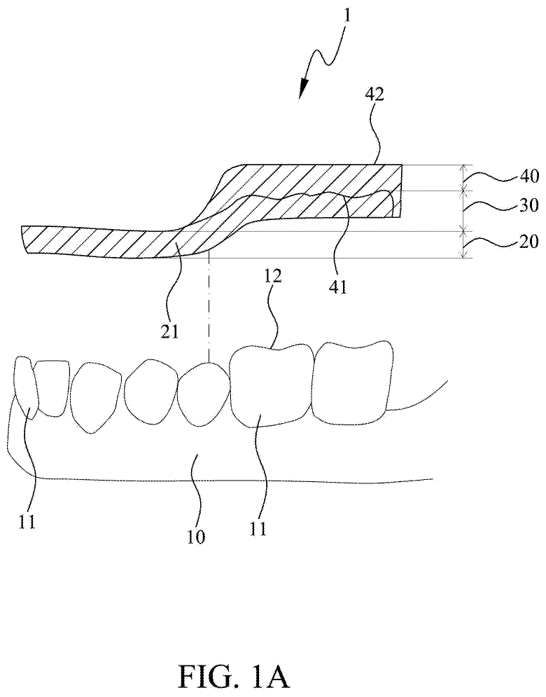

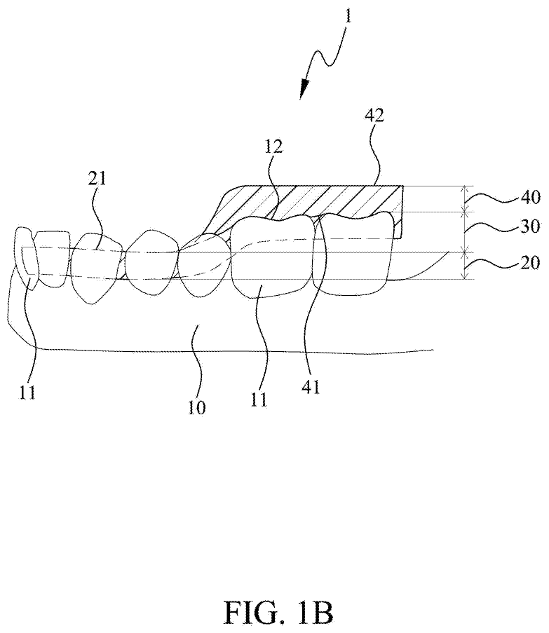

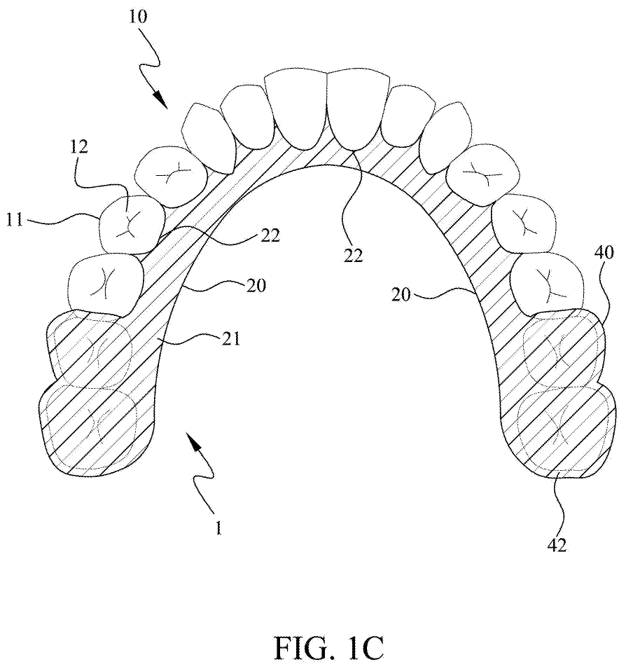

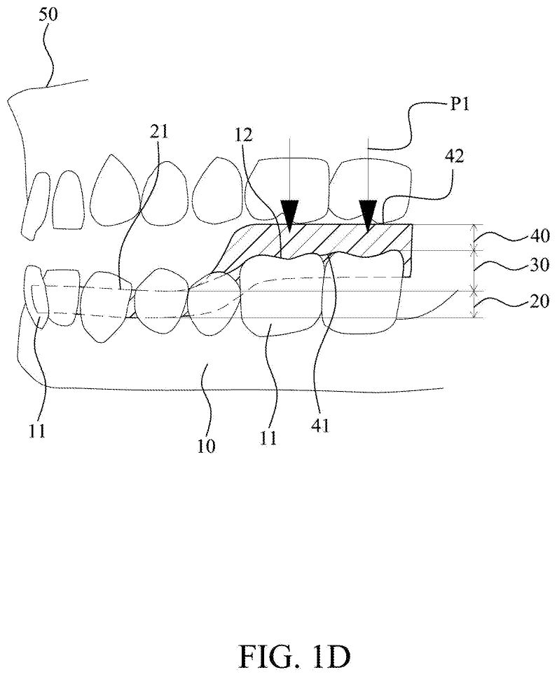

Referring to FIGS. 1A to 1C, in a first preferred embodiment, a brace 1 of the present invention is used in a corrective dental arch 10 of a patient. The corrective dental arch 10 has a plurality of teeth 11 with different shapes, such as incisors, canines and molar teeth, each of the teeth 11 on the corrective dental arch 10 has an occlusal surface 12 with a height at a side that is away from the gum so that the height of each occlusal surface 12 differs from each other. In this preferred embodiment, the corrective dental arch 10 can be an upper dental arch or a lower dental arch of the patient.

As shown in FIGS., the brace 1 has two elastic arms 20, one of the elastic arms 20 is integratedly formed with the other elastic arm 20 to form a U-shaped elastic arm 21. An outer side surface of the U-shaped elastic arm 21 forms a corrective contour 22 that conforms an inner side surface shape of the corrective dental arch 10. In addition, the size of the U-shaped elastic arm 21 is smaller than that of the corrective dental arch 10, and the corrective contour 22 of the U-shaped elastic arm 21 is identical to an inner side contour of the corrective dental arch 10. Two opposite ends of the U-shaped elastic arm extend in an integrated manner, respectively, to form an extensive portion 30 and a corrective portion 40 extended from the extensive portion 30 in sequence. A side surface of the corrective portion 40 forms a contacting surface 41 corresponding to the occlusal surface 12 and forms a flat corrective plane 42 at a side opposite to the contacting surface 41.

In a specific application of this embodiment, the brace 1 is mounted in the corrective dental arch 10 so that the U-shaped elastic arm 21 is located at a lingual side of the corrective dental arch 10 (i.e., the inner side of the corrective dental arch 10), while one of the extensive portions 30 and one of the corrective portions 40 are located at one end of the corrective dental arch 10, and the other extensive portions 30 and the other corrective portions 40 are located at the other end of the corrective dental arch 10. As shown in FIG. 1B, the U-shaped elastic arm 21 does not exceed the occlusal surface 12 of the corrective dental arch 10 with a lowest height, and a height of the extensive portions 30 at a side away from the elastic portions 20 is as high as the occlusal surface 12 of the corrective dental arch 10 with a highest height; also, the corrective contour 22 of the U-shaped elastic arm 21 is in contact with an inner surface of the corrective dental arch 10, and a contacting surface 41 of the corrective portions 40 is in contact with the occlusal surface 12 of the corrective dental arch 10 with the highest height when the brace 1 is mounted in the corrective dental arch 10; such that the height of the corrective portions 40 exceeds the height of each occlusal surface 12. Therefore, the U-shaped elastic arm 21 will not deform due to push from the corrective dental arch 10 when the brace 1 is mounted in the corrective dental arch 10, because corrective contour 22 of the brace 1 is identical to the inner side contour of the corrective dental arch 10.

Subsequently, as shown in FIG. 1D, the corrective dental arch 10 and an occlusal dental arch 50 at a side of the corrective dental arch 10 occlude, wherein a portion of the teeth of the occlusal dental arch 50 is not in contact with the occlusal surfaces 12 of the corrective dental arch 10, while the remaining portion of the teeth of the occlusal dental arch 50 is in contact with the corrective plane 42 of the corrective portions 40. Accordingly, a correcting force P1 perpendicular to the occlusal surfaces 12 with a height surface is formed by the corrective portions 40 and applied to the teeth 11 to be corrected, such that the portion of the teeth 11 of the corrective dental arch 10 can be corrected by the correcting force P1 to improve malocclusion between the corrective dental arch 10 and the occlusal dental arch 50. In this embodiment, if the corrective dental arch 10 is a lower arch of the patient, the occlusal dental arch 50 is an upper arch of the patient; in turn, if the corrective dental arch 10 is the upper arch of the patient, the occlusal dental arch 50 is the lower arch of the patient.

In this embodiment, because the occlusal surface 12 of molar teeth of the corrective dental arch 10 is higher than the occlusal surfaces 12 of the rest of teeth 11, the corrective portions 40 is located above the molar teeth of the corrective dental arch 10 when the brace 1 is mounted in the corrective dental arch 10. Furthermore, the incisors and canines of the occlusal dental arch 10 are not in contact with the occlusal surfaces 12 of the incisors and canines of the corrective dental arch 10, and the molar teeth of the occlusal dental arch 50 are in contact with the corrective plane 42 of the corrective portions 40 when the occlusal dental arch 50 occlude with the corrective dental arch 10; therefore, the molar teeth of the corrective dental arch 10 are corrected by the correcting force P1 and gradually reduce the height, and the occlusal surface 12 of molar teeth of the corrective dental arch 10 are thus aligned with the occlusal surfaces 12 of other teeth 11 (such as, the incisors and canines) of corrective dental arch 10. After the correction, each of the teeth 11 of the corrective dental arch 10 can be in contact with each of the teeth of the occlusal dental arch 50, respectively, which allows the corrective dental arch 10 to fully occlude with the occlusal dental arch 50.

It is noted that the molar teeth of the corrective dental arch 10 corrected by the correcting force P1 is merely provided by way of example. The relative position between the elastic arms 20 and the corrective portions 40 can be changed that depends on the position of the highest occlusal surface of teeth. Therefore, the corrective portions 40 can be in contact with incisors or canines of the corrective dental arch 10 for correcting when the brace 1 is mounted in the corrective dental arch 10.

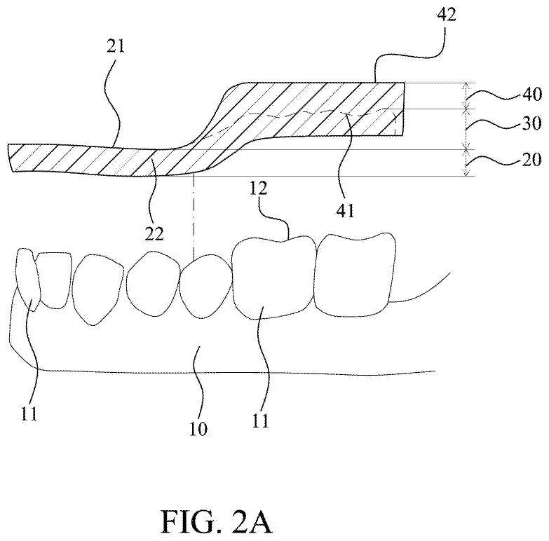

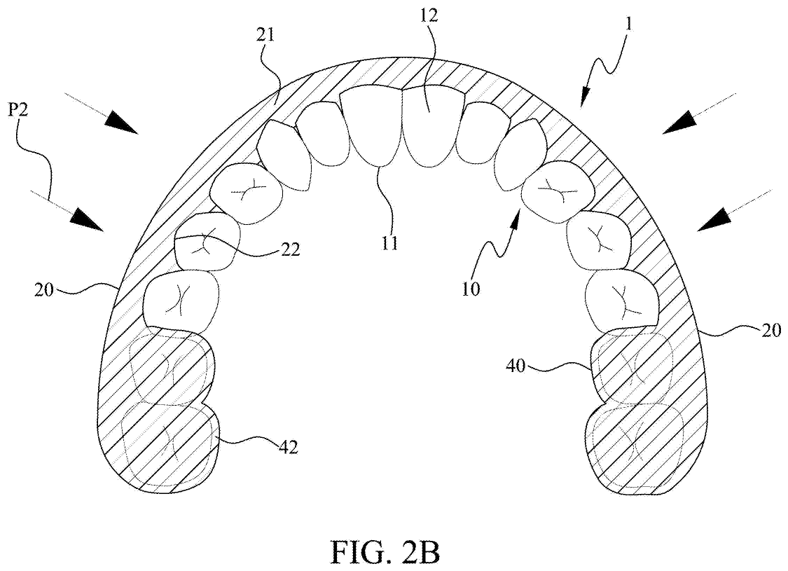

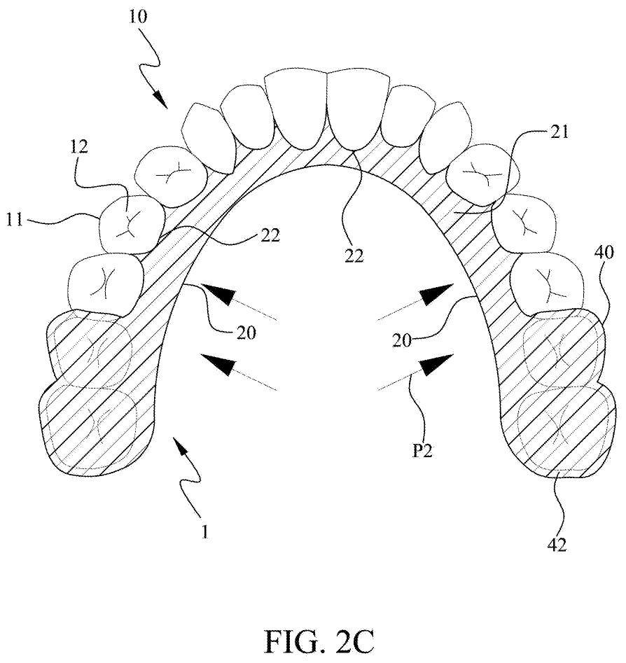

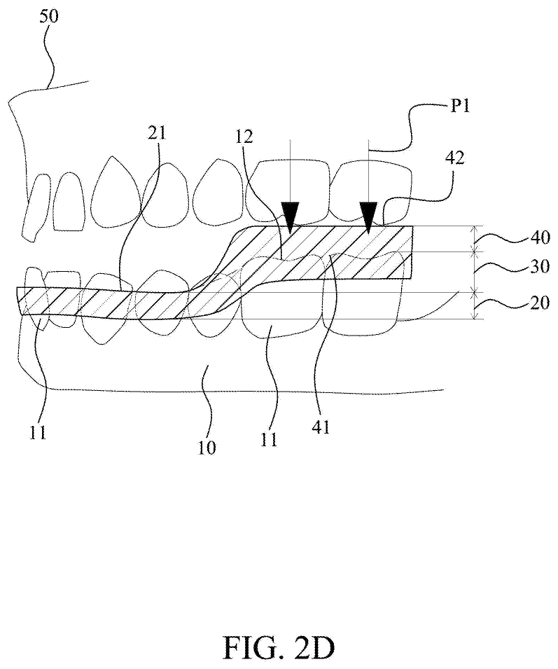

Referring to FIGS. 2A and 2B, in a second preferred embodiment, the difference from the first preferred embodiment is that the shape of a U-shaped elastic arm 21 is larger than the corrective dental arch 10, and a corrective contour 22 is located at an inner side of the U-shaped elastic arm 21 and is similar to an outer side surface shape of the corrective dental arch 10. In addition, the corrective contour 22 of the U-shaped elastic arm 21 is smaller than an outer side contour of the corrective dental arch 10. However, the same as the first preferred embodiment, the extensive portions 30 is integratedly formed from the elastic arms 20, and the corrective portions 40 is integratedly formed from the extensive portions 30. Also, the structures of the extensive portions 30 and correct portions 40 are the same as the first preferred embodiment, so these elements will not be described again.

In a specific application of this embodiment, the U-shaped elastic arm 21 is located at a buccal side of the corrective dental arch 10 (i.e., the outer side of the corrective dental arch 10) when the brace 1 is mounted in the corrective dental arch 10. One of the extensive portions 30 and one of the corrective portions 40 are the same as being located at one end of the corrective dental arch 10, and the other extensive portions 30 and the other corrective portions 40 are located at the other end of the corrective dental arch 10. As shown in FIGS., the U-shaped elastic arm 21 is the same as in the first embodiment for not exceeding the occlusal surface 12 of the corrective dental arch 10 with a lowest height, and a height of the extensive portions 30 at a side away from the elastic portions 20 is the same for being as high as the occlusal surface 12 of the corrective dental arch 10 with a highest height; also, the corrective portions 40 exceed and are in contact with the occlusal surface 12 of the corrective dental arch 10 with the highest height; wherein the corrective contour 22 of the U-shaped elastic arm 21 is in contact with the outer side surface of the corrective dental arch 10 when the brace 1 is mounted in the corrective dental arch 10. Therefore, because the corrective contour 22 of the brace 1 is smaller than the outer side contour of the corrective dental arch 10, the U-shaped elastic arm 21 is expanded and deformed due to push from the corrective dental arch 10, which further causes each of the elastic arms 20 to deform utilizing a connection between two of the elastic arms 20 as supporting points so as to form a flexible force P2 substantially parallel to the occlusal surface 12 that corrects the corrective dental arch 10.

It is noted that the U-shaped elastic arm 21 being located at the buccal side of the corrective dental arch 10 to allow that the flexible force P2 is generated by the two elastic arms 20 due to push from the corrective dental arch 10 is merely provided by way of example, as shown in FIG. 2C, the corrective contour 22 can form the outer side surface of the U-shaped elastic arm 21, and can be larger than the inner side contour of the corrective dental arch 10. Therefore, the corrective contour 22 of the U-shaped elastic arm 21 is in contact with the inner side surface of the corrective dental arch 10 when the brace 1 is mounted in the corrective dental arch 10, such that the U-shaped elastic arm 21 is located at the lingual side of the corrective dental arch 10, and the flexible force P2 is generated by shrinkage deformation of the two elastic arms 20 due to push and press from the corrective dental arch 10.

In addition, the occlusal dental arch 50 occlude with the corrective dental arch 10 as shown in FIG. 2D, so a portion of teeth (the molar teeth in this FIG.) of the occlusal dental arch 50 is in contact with the corrective plane 42 of the corrective portions 40 to generate the correcting force P1, while the rest of the teeth (the incisors and canines in this FIG.) of the occlusal dental arch 50 are not in contact with the corrective dental arch 10. Accordingly, in this embodiment, the corrective dental arch 10 can be corrected simultaneously by the correcting force P1 and the flexible force P2 when occluding with the occlusal dental arch 50 thereby reducing the correction time and increasing efficiency.

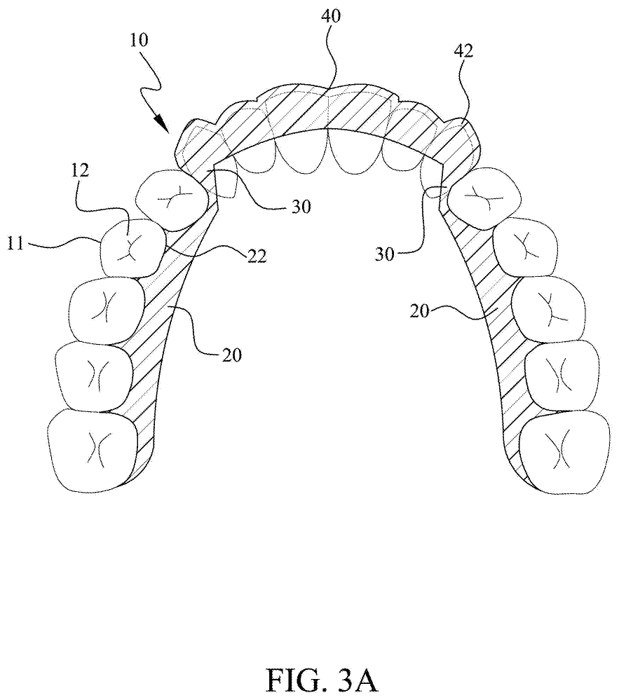

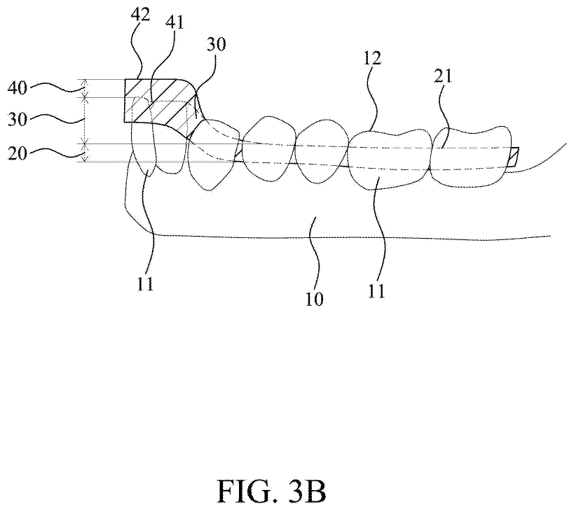

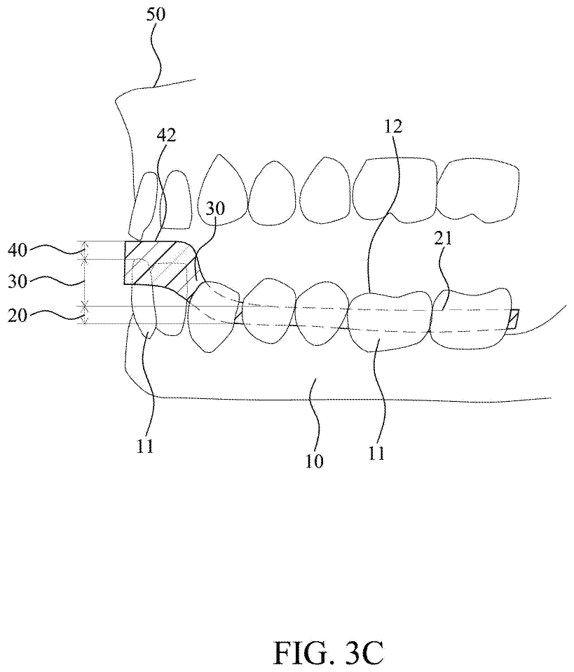

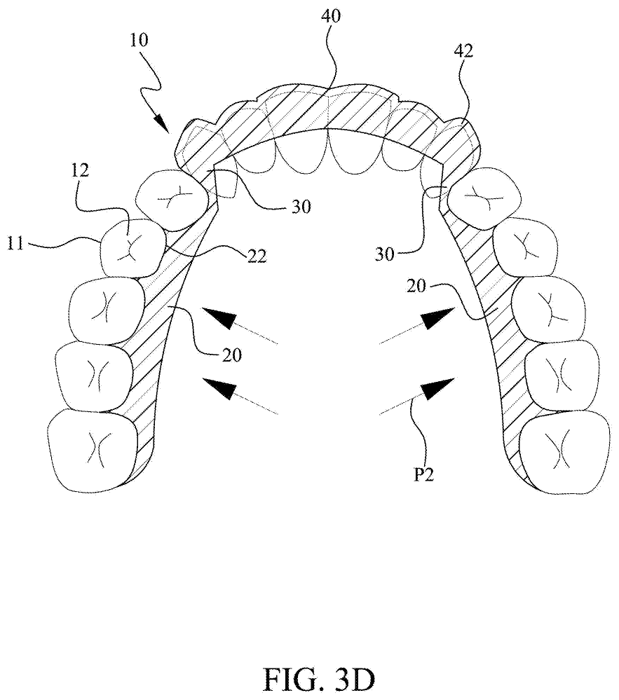

Referring to FIGS. 3A and 3B, in a third preferred embodiment, the difference from the first preferred embodiment is the amount and arrangement of the elastic arms 20, extensive portions 30 and corrective portions 40. In this embodiment, two opposite sides of a brace 1 of the present invention have an elastic arm 20 that can be located at the inner side of the corrective dental arch 10, respectively, and corrective portions 40 are located on the middle of the two elastic arms 20 and accordingly located on a central segment of the corrective dental arch 10. Furthermore, an extensive portion 30 is formed between each of the elastic arms 20 and corrective portions 40, such that the corrective portions 40 are connected to the two elastic arms 20 via the two extensive portions 30. Therefore, a corrective contour 22 is formed jointly by the elastic arms 20, extensive portions 30 and corrective portions 40.

As shown in FIGS., in this embodiment, all the elastic arms 20 do not exceed the occlusal surface 12 of the corrective dental arch 10 with the lowest height when the brace 1 is mounted in the corrective dental arch 10, and the corrective portions 40 still exceed the occlusal surface 12 of the corrective dental arch 10 with the highest height. The two elastic arms 20 are located at the lingual side of the corrective dental arch 10 and cover a portion of the surface of the lingual side, such that the other portion of the surface of the lingual side is exposed; also, the contacting surface 41 of the corrective portions 40 is in contact with the incisors of the corrective dental arch 10. However, in this embodiment, the elastic arms 20 can be located at the buccal side of the corrective dental arch 10 other than the lingual side; and the corrective contour 22 can be the same as the first embodiment as being located at the inner or outer side of the corrective dental arch 10, or can be the same as the second embodiment as being larger than the inner side contour of the corrective dental arch 10 or being smaller than the outer side contour of the corrective dental arch 10. As shown in FIG. 3D, the elastic arms 20 can deform utilizing the extensive portions 30 as supporting points to generate a flexible force P2 when the corrective contour 22 is larger or smaller than the corrective dental arch 10.

As shown in FIG. 3C, when the occlusal dental arch 50 occludes with the corrective dental arch 10, a portion of the teeth (incisors in this FIG.) of the occlusal dental arch 50 is in contact with the corrective portions 40 to generate the correcting force P1 through which the incisors of the corrective dental arch 10 are corrected and the heights thereof are altered. Therefore, the occlusal surfaces 12 of the incisors of the corrective dental arch 10 can be aligned with the occlusal surface 12 of other teeth 11, such as canines and molar teeth, of the corrective dental arch 10.

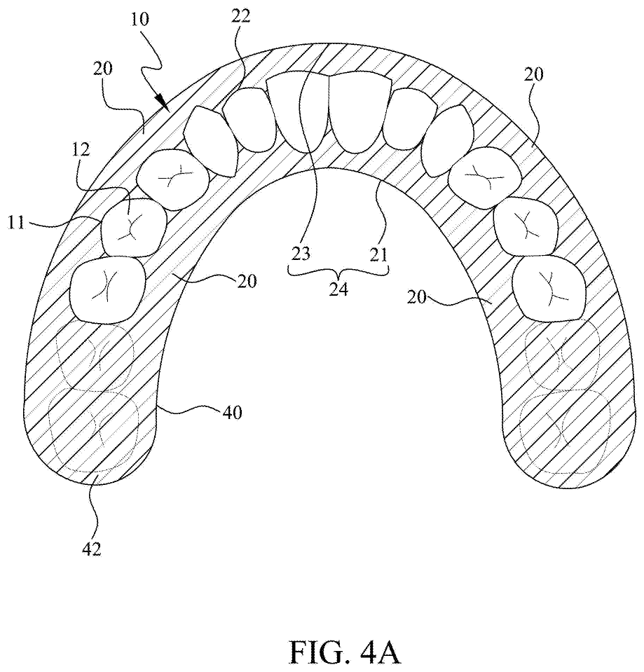

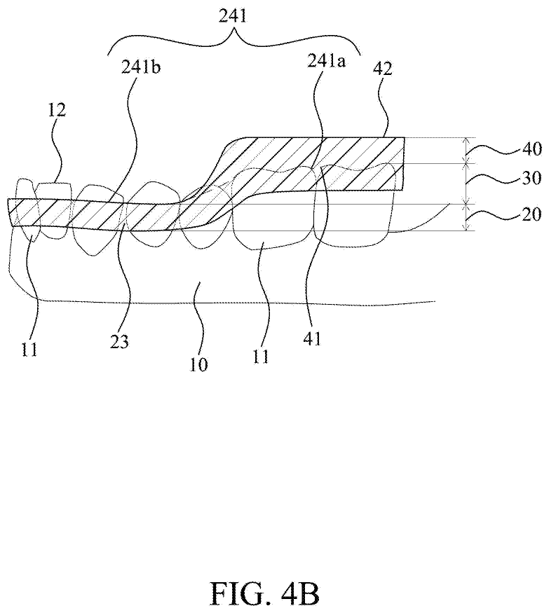

Referring to FIGS. 4A and 4B, in a forth preferred embodiment, the difference from the first preferred embodiment is that a plurality of elastic arms 20 connect with each other and further form an auxiliary U-shaped elastic arm 23 that connects with the U-shaped elastic arm 20 to form a hollow surrounding arm 24. The hollow surrounding arm 24 forms a corrective contour 22 at its inner side surface, and forms an opening 241 at its top end, wherein two opposite ends of the hollow surrounding arm 24 form extensive portions 30 and corrective portions 40, respectively. Furthermore, the extensive portions 30 are located at the top end of the hollow surrounding arm 24, and the corrective portions 40 are located above the opening 241, such that a portion of the opening 241 is covered by the corrective portions 40 to form a covering portion 241a, while the rest portion of the opening 241 is not covered by the corrective portions 40 to form an exposure portion 241b.

As shown in FIGS., the hollow surrounding arm 24 surrounds an outer perimeter of the entire corrective dental arch 10 when the brace 1 is mounted in the corrective dental arch 10, and the U-shaped elastic arm 21 is located at the lingual side of the corrective arch 10, while the auxiliary U-shaped elastic arm 23 is located at the buccal side of the corrective arch 10. Furthermore, the two extensive portions 30 and corrective portions 40 are located at the two opposite sides of the corrective arch 10, respectively. Also, only the corrective portions 40 exceed the occlusal surface 12 of the corrective dental arch 10 with the highest height, and all the elastic arms 20 do not exceed the occlusal surface 12 of the corrective dental arch 10 with the lowest height. In addition, a portion of the teeth 11 (incisors and canines in this FIG.) penetrates through the opening 241 to be located at the exposure portion 241b, and the rest portion of the teeth 11 (molar teeth in this FIG.) of the corrective dental arch 10 is located at the covering portion 241a of the opening 241 and is in contact with the contacting surface 41 of the corrective portions 40. In this embodiment, the way of the corrective portions 40 generating the correcting force P1 is the same as the first, second and third embodiment by occluding of the corrective dental arch 10 with the occlusal dental arch 50, and will not be described again. However, the corrective contour 22 can be the same or not the same with an outer contour of the corrective dental arch 10.

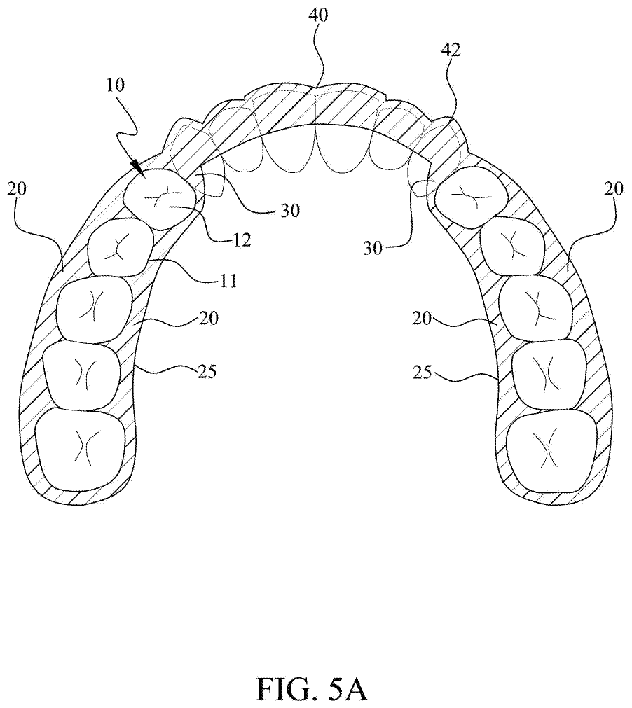

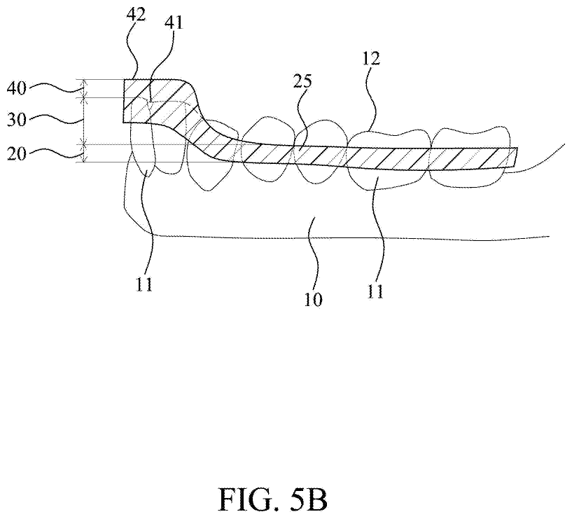

Referring to FIGS. 5A and 5B, in a fifth preferred embodiment, a brace 1 of the present invention has four elastic arms 20, two of which jointly surround and form a connecting ring 25 with it inner hollowed. The two connecting rings 25 form an extensive portion 30, respectively, and the two extensive portions 30 are connected via one corrective portion 40, such that the two connecting rings 25, two extensive portions 30 and one corrective portion 40 jointly form a corrective contour 22. In this embodiment, when the brace 1 is mounted in the corrective dental arch 10 each connecting ring 25 surrounds a portion of teeth 11 of the corrective dental arch 10, so a portion of the elastic arms 20 is located at the lingual side of the dental arch 10 and the rest portion of the elastic arms 20 is located at the buccal side. As shown in FIGS., when the two connecting rings 25 are mounted around molar teeth of the corrective dental arch 10 each of the elastic arms 20 does not exceed the occlusal surface 12 of the corrective dental arch 10 with the highest height, and the corrective portions 40 are located above incisors of the corrective dental arch 10 so that the corrective portions 40 exceed the occlusal surfaces 12 of incisors of the corrective dental arch 10. Therefore, in this embodiment, the corrective portions 40 are able to correct the incisors of the corrective dental arch 10 when the corrective dental arch 10 occludes with the occlusal dental arch 50.

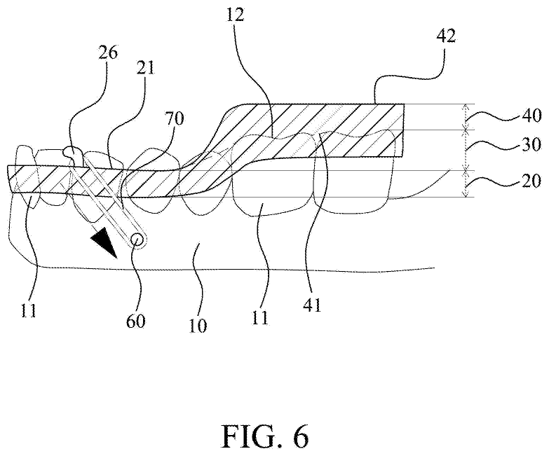

As shown in FIG. 6, in a sixth preferred embodiment, the elastic arms 20 of the second embodiment further extend to form a connecting portion 26, but connection relationships among the elastic arms 20, extensive portions 30 and corrective portions 40 are the same as the second embodiment, and will not be described again in this embodiment.

As shown in FIGS, a resilient member 70 is mounted between the connecting portion 26 and a bone screw 60 fixed on the corrective dental arch 10, and can apply an external force P3 to the elastic arms 20 in a direction different from the correcting force P1; therefore, the corrective dental arch 10 can correct the teeth 11 by the external force P3 in order to reduce the occlusal surface 12 of the corrective dental arch 10 with a highest height, even when the corrective dental arch 10 does not occlude with the occlusal dental arch 50 to enable the corrective portions 40 to generate the corrective force P1. It is noted that the connecting portion 26 being formed on the elastic arms 20 is merely provided by way of example, the connecting portion 26 can also be formed on the extensive portions 30 or corrective portions 40.

Embodiments above have been described for the purpose of illustration, and not by way of limitation. Various simple alterations and amendments made by those skilled in the art according to the claims and illustrations of the present application without departing the spirit and scope of the present invention shall be included in the following claims.

What is claimed is:

1. A brace which can be mounted in a corrective dental and be used with an occlusal dental arch located on a side of the corrective dental arch, the corrective dental arch having a plurality of occlusal surfaces with different heights, the brace comprising:
a plurality of elastic arms being in contact with an inner or an outer side of the corrective dental arch, and not exceeding one of the plurality of occlusal surfaces with a lowest height;
at least one extensive portion, one end of which is formed on the plurality of elastic arms, and a height of the other end of which is as high as one of the plurality of occlusal surfaces with a highest height; and
at least one corrective portion being in contact with the occlusal surface with the highest height, and being formed on the at least one extensive portion, the at least one corrective portion forming a corrective plane at a side that is away from the plurality of occlusal surfaces,
wherein a portion of the corrective dental arch is corrected by a correcting force that is substantially perpendicular to the one of the plurality of occlusal surfaces with the highest height when the corrective plane occludes with the occlusal dental arch.

2. The brace as claimed in claim 1, wherein the brace has a contour that is larger or smaller than a corrective contour of the corrective dental arch, and the plurality of elastic arms are deformed due to a press or expansion from the corrective dental arch when the brace is mounted in the corrective dental arch, so a flexible force that is substantially parallel to the plurality of occlusal surfaces is generated by the plurality of elastic arms to correct the corrective dental arch.

3. The brace as claimed in claim 2, wherein the plurality of elastic arms connects with each other to form a U-shaped elastic arm, an inner side or an outer side of the U-shaped elastic arm forms the corrective contour, and the plurality of elastic arms utilize a connection between two of the elastic arms as supporting points to deform so as to form the flexible force.

4. The brace as claimed in claim 3, wherein two opposing ends of the U-shaped elastic arm have the at least one extensive portion and the at least one corrective portion, respectively.

5. The brace as claimed in claim 3, wherein the plurality of elastic arms connect with each other to further form an auxiliary U-shaped elastic arm connected to the U-shaped elastic arm, and the U-shaped elastic arm and the auxiliary U-shaped elastic arm jointly compass the corrective dental arch, so one of the U-shaped elastic arm and the auxiliary U-shaped elastic arm is located at the inner side of the corrective dental arch and the other of the U-shaped elastic arm and the auxiliary U-shaped elastic arm is located at the outer side of the corrective dental arch.

6. The brace as claimed in claim 5, wherein the U-shaped elastic arm and the auxiliary U-shaped elastic arm jointly form an opening through which the corrective dental arch extends, and the at least one extensive portion is above the U-shaped elastic arm and the auxiliary U-shaped elastic arm, so the opening has a covering potion covered by the at least one corrective portion and exposure portion not covered by the at least one corrective portion.

7. The brace as claimed in claim 2, wherein two opposing ends of the at least one corrective portion form the at least one extensive portion and the plurality of elastic arms, respectively, the plurality elastic arms, the at least one extensive portion and the at least one corrective portion jointly form the corrective contour, and the plurality of elastic arms utilize the at least one extensive portion as supporting points to deform so as to generate the flexible force.

8. The brace as claimed in claim 7, wherein the plurality of elastic arms connects with each other and is formed at the one end of the at least one extensive portion that is away from the at least one corrective portion, so the plurality of elastic arms jointly compasses a portion of the corrective dental arch.

9. The brace as claimed in claim 1, wherein one of the elastic arms, the at least one extensive portion and the at least one corrective portion has a connecting portion that connects to a resilient member, so an external force is applied to the plurality of elastic arms by the resilient member in a direction that is different from the correcting force.
